(19) United States
(12) Patent Application Publication
(10) Pub. No.: US 2005/0193850 A1
(43) Pub. Date: Sep. 8, 2005

(54) Power transmission device for power tool

(75) Inventors: Noriyuki Sasaguchi, Hiroshima (JP); Naotaka Ora, Hiroshima (JP)

Correspondence Address: Richard S. Roberts;ROBERTS & ROBERTS, L.L.P., P.O. Box 484, Princeton, NJ, 08542-0484, US

(73) Assignee: Shibuya Company, Ltd.

(21) Appl. No.: 11/042,577

(22) Filed: Jan. 25, 2005

(30) Foreign Application Priority Data
Feb. 27, 2004 (JP) P2004-055225

(51) Int. Cl. F16H 61/58

(52) U.S. Cl. 74/412 TA

(57) ABSTRACT

The present invention relates to a power transmission device for a power tool, more specifically for a core drill, which device is capable of transmitting predetermined torque in a stable manner and for longer period of time under a condition where a clutch slips. The power transmission device for a core drill comprises of: a gear 30 to which rotation from a power source is input; a disk-shaped rotator 41, 50, which is disposed coaxially with the gear 30 and transmits rotation of the gear 30 to the tip tool side; friction members, which are installed between the gear and rotator and kept pressed against the side face or faces of the gear and/or rotator, and said power transmission device transmitting rotation of the gear to the rotator with the use of friction caused between the gear 30 and/or rotator 41, 50 and the friction members, and as friction members, friction members 70 having two or more friction faces 70a which are spaced apart from each other are used.

### TECHNICAL FIELD

The present invention relates to a power transmission device for a power tool, which transmits rotation to a tip tool, and particularly relates to a power transmission device characterized by a clutch mechanism.

### BACKGROUND OF THE INVENTION

A powered tool such as for example a core drill is normally provide at a power transmission device thereof with a clutch to prevent excessive torque from being imposed on a motor as a source of power. A power tool which requires small size and light weight generally adopts so called a slip clutch having a relatively simple structure. The slip clutch is structured to have a disk-shaped or toroidal friction plate comprised of a flat plate held tight between a gear and a clutch disk or a rotational object such as for example a rotary shaft, thereby is adapted to transmit turning force with the use of friction between contact surfaces pressed against each other (see Japanese Patent Application Laid-open No. Hei10-296574). Maximum torque values transmittable via a slip clutch can be adjusted via adjustment of the strength of pressure, and when transmitted torque has reached its predetermined maximum torque, the friction plate comes into a slip condition, thereby preventing a motor from being imposed by excessive torque.

Incidentally, when an operating efficiency is taken into consideration, a powered tool is desirable if it sustains as much as possible long hours of use while a clutch is in operation. Specifically, a slip clutch for use in a powered tool is desirable if it can continue transmitting predetermined torque from a motor side to a tip tool side in a stable manner as long as possible even under a slipped condition.

However, there have been such defects in the conventional slip clutches that as the number of slips or total slip time increases, transmission torque under a slipped condition drastically deteriorates or seizure develops in a relatively short period of time. Thus, the conventional powered tools can be of service for only a relatively short period of time once a slip clutch is in a slipped condition.

The present invention has been made in view of the above problems, and it is an object of the invention to provide a power transmission device for a power tool, which is capable of transmitting predetermined torque in a stable manner and for longer period of time under a condition where a clutch slips, and further to provide a core drill using the power transmission device.

### DISCLOSURE OF THE INVENTION

The present invention provides a power transmission device for a power tool, comprising: a gear to which rotation from a power source is input; a disk-shaped rotator, which is disposed coaxially with the gear and transmits rotation of the gear to the tip tool side; friction members, which are installed between said gear and rotator and kept pressed against the side face or faces of the gear and/or rotator, and the power transmission device transmits rotation of the gear to the rotator with the use of friction caused between the gear and/or rotator and the friction members, characterised in that the friction members have two or more friction faces which are spaced apart from each other.

When divided into two or more sections, the friction faces of the friction members will be formed with gaps through which lubricant is facilitated to flow or by which lubricant is resupplied to the friction faces in a facilitated manner. Upon this division, material shavings generated during slip can be readily discharged together with lubricant. Further, such gaps facilitate divergence of heat generated due to friction. Thus, improvement in resuppliability of lubricant, divergeability of heat, and dischargeability of material shavings will prevent the status of the friction faces under a slip condition from changing suddenly, thereby will further stabilize transmission torque under a slip condition and allow stable and long-hour transmission of torque. Stable torque contributes to good operationality of a power tool under a slip condition, and for instance an operation for stopping a power tool can be effected promptly, readily and credibly. As the friction members, an example can be given where radial or concentric grooves have been formed in a friction face of a toroidal friction member composed of a flat plate. When resuppliability of lubricant, divergeability of heat, and dischargeability of material shavings are taken into consideration, radially-grooved friction members are more preferable than concentrically-grooved ones.

Although it is conceivable that oiled friction faces of the friction members of the slip clutch will withstand longer-time slip operation, however the friction faces of the friction members are in close contact with the counterparts, so that it is difficult to oil onto the friction faces even if the lubricant is of low viscosity. For example in a hand-held power tool, grease of high viscosity is often used from a viewpoint of maintenance-free operation, to lubricate periphery of the friction members. In such a case, oiling onto the friction members is more difficult than a case where lubricant of low viscosity is used. In this respect, the present invention will be more preferable for stabilizing transmission torque and improving durability of a hand-held power tool in which grease is used for lubrication, because the present invention does not oil onto the friction members but divides them into two or more sections to stabilize the transmission torque under a slip condition and thereby improve durability.

The present inventors further studied about a structure which stabilizes torque under a slip condition of the friction members. The friction members are normally used under a pressurized condition, slip-initiation torque is mainly adjusted in consideration of face conditions of the friction faces of the friction members and intensity of the pressurization. Conventional slip clutches adopt a structure in which friction members are sandwiched from both sides thereof, and both side faces of the friction members serve as a friction face. However, it is rare the face conditions of both the friction members are the same, and rather normal the face conditions are different from each other. Thus, if pressurizing is set up with respect to a plurality of friction members having different face conditions, the number of correlation between pressurizing and the friction faces and the number of friction faces will be the same, and also the slip-initiation torque will be set up with respect to each friction face. However, both sides of the friction plate are two sides of the same plate, which shows an example of no simple peripheral conditions of the friction members, whereby it is not easy to comprehend both the set-up conditions. Further, when friction faces exist plurally, a slippery friction face will slip preferentially, so that only one of the friction faces will substantially serve as a friction face in most cases. In such a case, set-up should be made in conformity with a slippery friction face, however it is actually no easy to determine which is a most slippery friction face.

In view of the above study results, it is preferable if an installation structure of the friction members is such that the friction members should be installed into any of a gear or a rotator, which are in contact with the friction members, rather than the friction members should be held tightly at both sides thereof in a manner as has been conventionally done. Thus, such a structure in which the friction members has been installed into a gear or a rotator will provide single-sided friction faces allows the slip initiation torque to be readily and accurately set up. When assemblability is taken into consideration, it is more preferable if the structure has the friction members installed in the gear.

Further study was made on a power transmission device, which is more excellent in durability. For instance, in conventional slip clutches employing conventional toroidal friction members comprised of flat plates, seizure is often caused to the friction members in the course of use the members. In this respect for instance, forming radial grooves in a friction face of a toroidal friction member to divide the friction face into two or more sections realized improvement to some degrees but was not sufficient. Subsequent detailed studies made in the friction faces of the friction members revealed that it is assumed not entire face of the conventional friction members is necessarily in contact with a counterpart from a microscopic point of view. More specifically, it was assumable from the studies that very small area of the entire friction face actually serves as a friction face. Because of the very small area actually in contact, it is assumed pressure far exceeding an average surface pressure (calculated value) has been applied locally. Under the conditions, rapid abrasion or material destruction such as surface peeling of the friction faces may occur, and destructed pieces generated by surface destruction of the friction faces may remain undischarged. If seizure occurs subsequently, slip function of the clutch will be lost.

Consequently, further studies revealed that it is more preferable if the friction member is comprised of two or more friction members, each of which is independently detachable with respect to the gear and has a friction face. This is ascribable to a fact that the friction face of the friction members according to the present invention is smaller than the counterpart of the conventional tabular toroidal friction members, whereby a friction face with higher face accuracy is readily obtainable. This is also ascribable to an assumption that if friction member pieces having uniform and excellent face accuracy only are selected and used out of a plurality of those independently provided as a friction member, the face accuracy could be improved comparatively readily. According to the present invention, a friction face with higher face accuracy is available, and local imposition of greater pressure is positively prevented. As a result, seizure will be prevented from occurring on a friction face, whereby durability of a power transmission device will be increased.

A conceivable structure in which each friction member piece should be installed in a gear is for instance that holes into which friction member pieces should be installed are formed in a side face of a gear and into which projections formed on each friction member piece should be inserted in a releasable manner. Such a structure will be advantageous if the number of holes formed in the side face of the gear is relatively large and the number of friction member pieces to be installed into the gear is adjusted to alter the area of the friction face, which is one of face conditions of the friction face. For instance, when the number of holes is six, in addition to a case where all the six holes are installed with friction member pieces, the area of the friction face can be adjusted if the friction member pieces are installed into two, three or four out of the six holes in a stepped manner. If the area of the friction face is successfully adjusted, then flexibility in setting up slip initiation torque which is set up with mainly face conditions of a friction face and pressure will be increased, thereby setting up the set-up torque, i.e. slip initiation torque to desirable torque will be facilitated. It should be noted maximum transmission torque is set up, for instance with rated torque of a motor equipped being taken into consideration.

Further, various shapes are conceivable with respect to the friction face to be formed on the friction member pieces, however circular form is preferable. The reason is that, unless the friction face is circular, the slip initiation torque is likely to vary depending on the orientation of the friction face even if the pressure is unchanged, however, if the friction face is circular, the relation between the pressure and friction face becomes constant irrespective of the orientation of the installed friction face. Furthermore, if the friction face is circular, the friction member pieces may be installed into the gear with no attention being paid to the orientation of the pieces, whereby installation is advantageously facile.

As described above, the power transmission device for a core drill according to the present invention allows predetermined torque to be transmitted in a stable manner under a slip condition of a slip clutch, whereby excelling in operationality of a power tool under a slip condition. Once operationality is established, the power tool can be stopped quickly, readily and reliably, for instance under a slip condition.

### BRIEF DESCRIPTION OF THE DRAWINGS

FIG. 1 is a perspective view showing a core drill according to embodiments;

FIG. 2 is a cross sectional view showing a power transmission section of a core drill;

FIG. 3 is an exploded perspective view showing components mounted to a first shaft of the power transmission section;

FIG. 4 is an enlarged perspective view showing a gear and friction members;

FIG. 5 is a cross sectional view showing a portion of an A-A cross section of FIG. 4;

FIG. 6 is a perspective view showing another application of the core drill according to the embodiments; and

FIG. 7 is a chart showing an electric current and voltage of a motor as results of slip operation tests.

### BEST MODE FOR CARRYING OUT THE INVENTION

Hereinafter, preferred embodiments of a core bit according to the present invention will be concretely described with reference to the drawings.

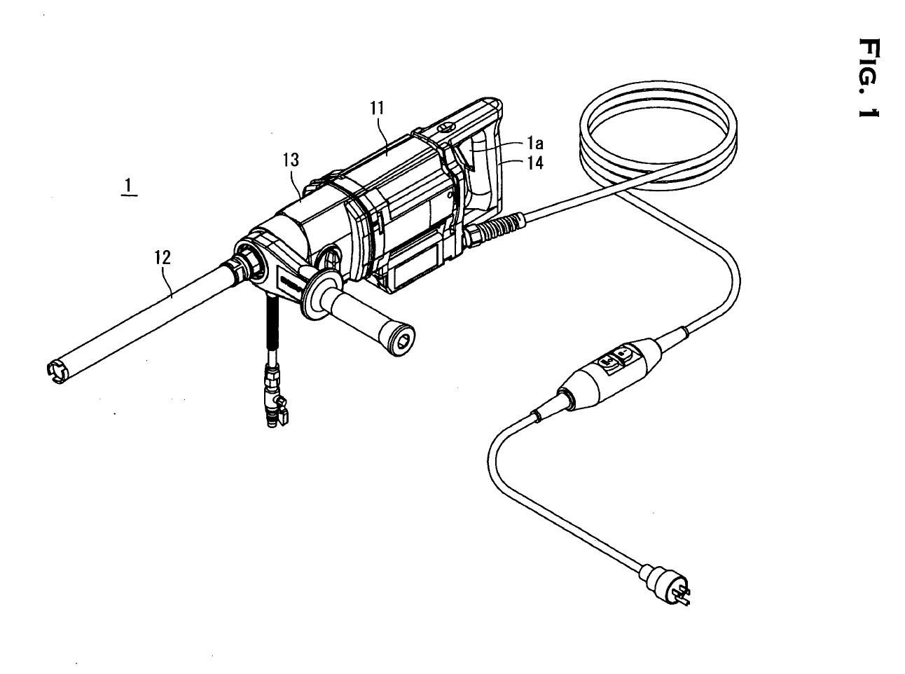

Symbol “1” in FIG. 1 indicates a so-called hand-held core drill, i.e. power tool. The core drill 1 has a motor 11 as a source of power integrally incorporated therein, and a power transmission section 13, i.e. power transmission device, which transmits rotation of the motor 11 is incorporated between the motor 11 and a core bit 12, i.e. tip tool. The core drill 1 further has a grip 14 on which a switch 1a is provided. Switching on or off the switch 1a operates or stops the core drill 1.

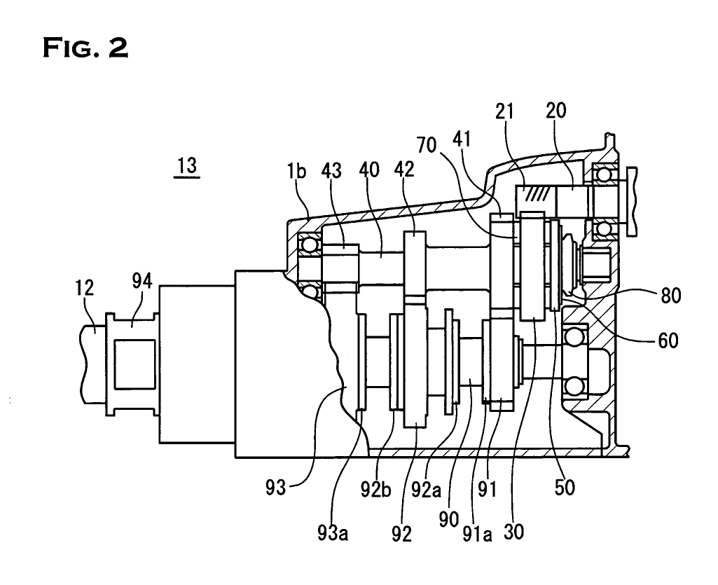

As FIG. 2 shows, the power transmission section 13 has a gear 30 meshing with a tip gear 21 of an input shaft 20 which transmits rotation of the motor 11. The gear 30 is equipped in a bore thereof with a bush 31, and the bush 31 is pivotally supported in a slidable manner on a first shaft 40 which is rotatably supported on a housing 1b of the core bit 12. Thus, the gear 30 rotates in concert with the rotation of the tip gear 21 of the input shaft 20, independently of the rotation of the first shaft 40. The first shaft 40 is integrally formed with three speed change gears for shifting gears, namely a first speed change gear 41, a second speed change gear 42, and a third speed change gear 43. Transmission of rotation from the gear 30 on the first shaft 40 to the speed change gears 41, 42, 43 is effected via a slip clutch mechanism which is now being described.

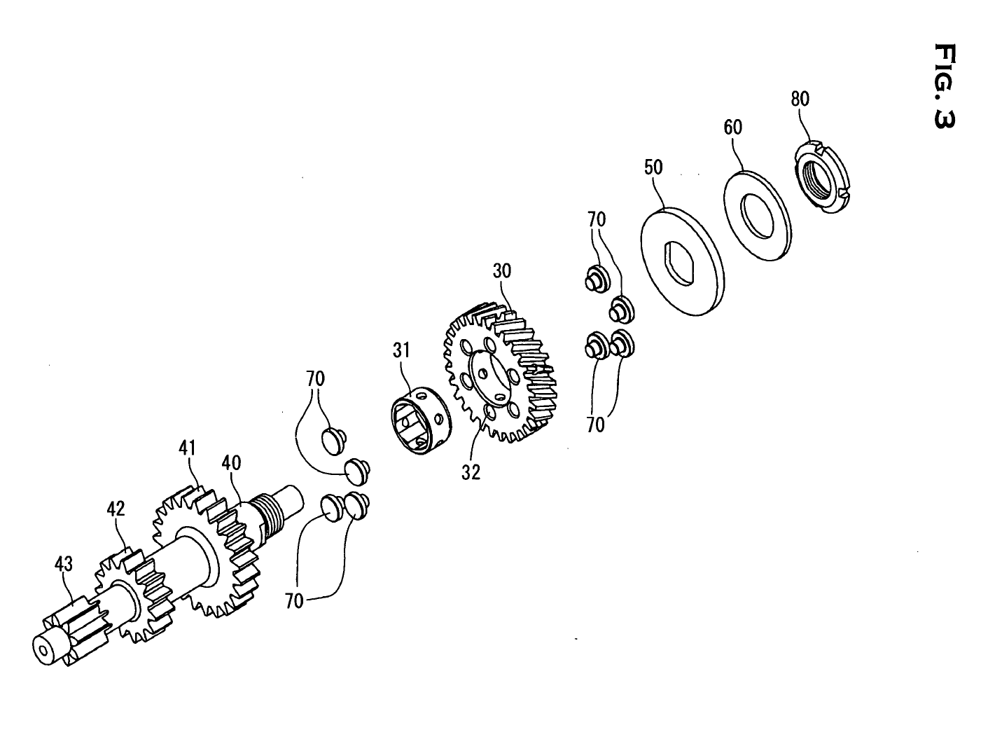

As FIGS. 2 and 3 show, such a plurality of components are fitted onto the first shaft 40 as, in addition to the speed change gears 41, 42, 43 and the gear 30, a disk-shaped clutch disk 50 and a belleville spring 60 which are positioned adjacent to the gear 30. Out of the components, the clutch disk 50 is integrally fixed to the first shaft 40, and the belleville spring 60 is rotatably fitted onto the first shaft 40. There is interposed friction members 70, i.e. friction pieces, between the gear 30 and the first speed change gear 41, and similarly interposed friction members 70 between the gear 30 and the clutch disk 50. Further, on the first shaft 40, there is screwed a clamping nut 80 for pressing the belleville spring 60 and the clutch disk 50 against the gear 30. The nut 80 is used to press the belleville spring 60 against the gear 30 side in a assembled state. Thus, the gear 30 and the first speed change gear 41, i.e. a rotator are in a state where they are pressed against each other via the friction members 70. Similarly, the gear 30 and the clutch disk 50, i.e. a rotator are in a state where they are pressed against each other via the friction members 70. Under the pressurized state, rotation of the gear 30 can be transmitted to the first speed change gear 41 and the clutch disk 50 with the use of friction.

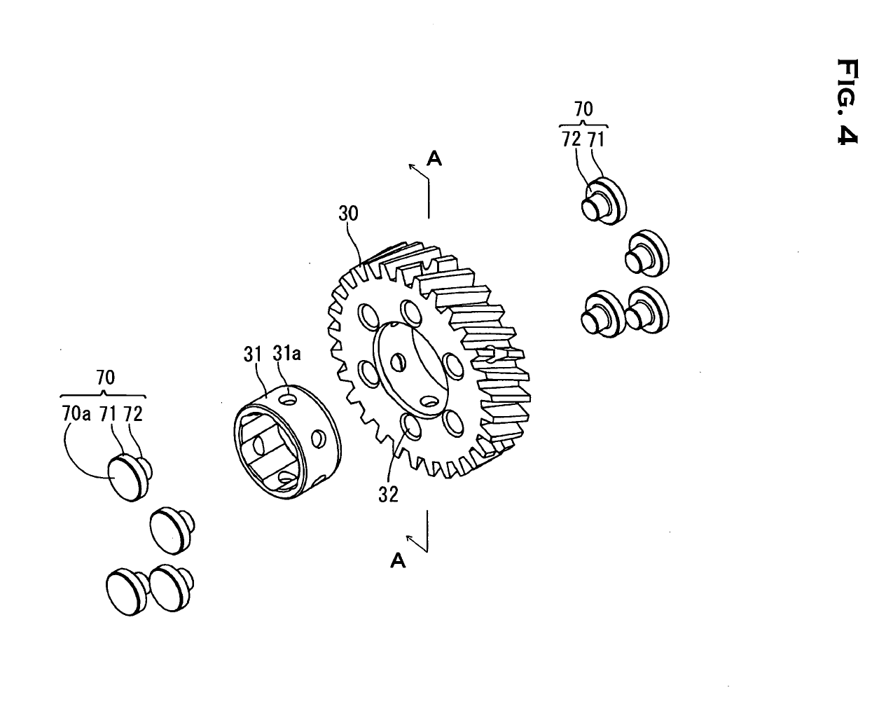

As FIG. 4 shows, the friction members 70 are a stepped cylindrical member integrally formed of a cylindrical larger-diameter-section 71 having a flat friction face 70a and a smaller-diameter-section 72, and the members 70 are fitted in the gear 30 for use. The gear 30 accepting the members 70 have six through-holes 32 opening to the both sides. Specifically, the friction members 70 are installed in the gear 30 with the smaller-diameter-section 72 fitted in through-holes 32 of the gear 30. Then, as the figure shows, the friction members 70 are installed in each side of the gear 30 by the number of four in the present embodiments. Each friction member 70 is independently installed in the gear 30 in a releasable manner, and is independently spaced apart the other friction members 70.

As will be understood from the above description, the first speed change gear 41 and the clutch disk 50 are in contact with the friction members 70 at a plurality of circular friction faces 70a, which are independently disposed. Therefore, rotation of the gear 30 is transmitted to the first speed change gear 41 and the clutch disk 50 via friction at the friction faces 70a. The first speed change gear 41 is integrally formed with the first shaft 40, and the clutch disk 50 is assembled so as to rotate integrally with the first shaft 40. Therefore, rotations of the first speed change gear 41 and the clutch disk 50 are transmitted directly to the first shaft 40. The core drill 1 has a structure in which a nut 80 is clamped to allow press the friction faces 70a against the first speed change gear 41 and the clutch disk 50, and maximum transfer torque of a power transmission section 13 is adjustable through adjustment of a clamped condition of the nut 80. Further in the core drill 1, the setting of the maximum transfer torque is also adjustable through increase or decrease of the number of friction members 70 to be installed in the gear 30.

As FIG. 2 shows, the power transmission section 13 has a second shaft 90 on which three gears, namely fourth, fifth and sixth speed change gears 91, 92, 93 driven by the speed change gears 41, 42, 43 on the first shaft 40, respectively are mounted, and rotation is transmitted from the first shaft 40 via these speed change gears to second shaft 90. Out of the driven speed change gears 91, 92, 93, only the fifth speed change gear 92 rotates constantly and integrally with the second shaft 90, and under the condition depicted by FIG. 2, rotation is transmitted from the second speed change gear 42 to the driven fifth speed change gear 92. The fifth speed change gear 92 is adapted to move longitudinally along the second shaft 90, and when the fifth speed change gear 92 moves on the right in the figure and meshes teeth 92a thereof with teeth 91a of the fourth speed change gear 91, rotation is transmitted from the first speed change gear 41 to the driven fourth speed change gear 91. In contrast, when the fifth speed change gear 92 moves on the left in the figure and meshes teeth 92b thereof with teeth 93a of the sixth speed change gear 93, rotation is transmitted from the third speed change gear 43 to the driven sixth speed change gear 93. The second shaft 90 is fitted at one end thereof with a mounting head 94 for fixing the core bit 12, and as the second shaft 90 rotates, the core bit 12 mounted to the mounting head 94 also rotates.

The number of holes formed in the gear 30 is six in the present embodiment, however any particular restriction is not imposed regarding the number, and any desirable number is applicable as far as the strength of the gear is maintained. Further in the present embodiment, through holes 32 are provided in a manner that the center of all the through holes 32 is positioned on a circle centering on a rotating shaft of the gear 30, however when the diameter of the gear 30 is extremely larger than that of the larger-diameter-section 71 of the friction members 70, the number of the circle centering on the rotating shaft of the gear 30 may be increased to two or more to increase the number of the holes through providing holes on each circle. Such holes to be provided are not necessarily through holes.

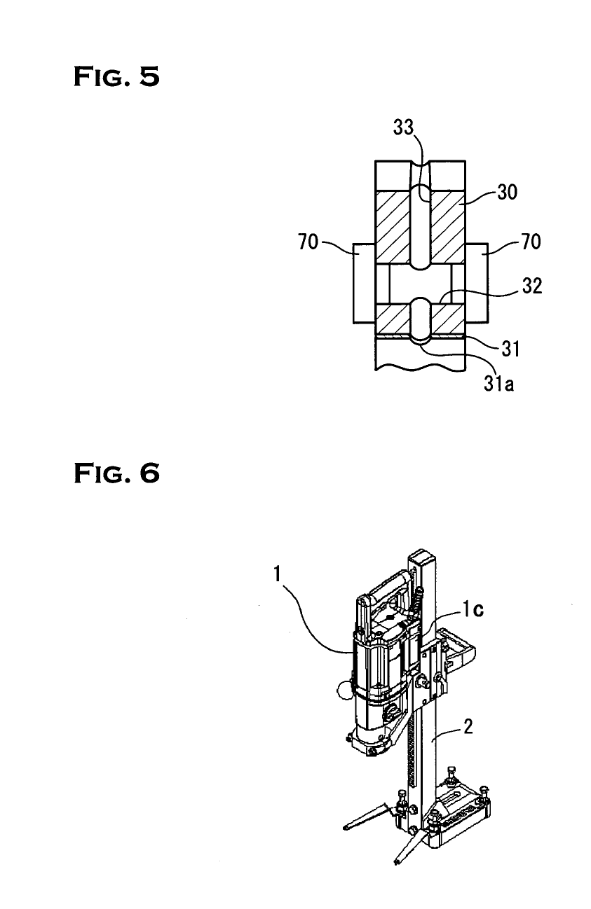

As FIG. 5 shows, the gear 30 has through holes 32 perforated to the both sides thereof and further has holes 33 orthogonal to the through holes 32 and extending radially. The holes 33 are through holes, which each has an opening on an internal surface facing the teeth of the gear 30 and first shaft 40. Further, as FIGS. 4 and 5 show, a metal bush 31 is also formed with holes 31a, and the metal bush 31 is fitted so that the holes 31a are communicated with the holes 33 of the gear 30. Therefore, each opening of the holes 33 of the gear 30 on the side of the first shaft 40 is communicated with the exterior via the holes 31a of the metal bush 31. The holes 31a and 33 are not indispensable, however if formed, lubricant supplied between the metal bush 31 and the first shaft 40 is supplied to the smaller-diameter-section 72 of the friction members 70 and to the teeth of the gear 30 through the holes 33. The lubricant supplied to the smaller-diameter-section 72 is further supplied to the friction faces 70a of the friction members 70 through gaps between the smaller-diameter-section 72 and the openings of the through holes 32. Especially, during operation of the core drill, the gear 30 is rotating, and larger quantity of lubricant is supplied via centrifugal force generated by the rotation. Thus, the gear 30 in Second embodiment will improve resuppliability of lubricant, heat dispersibility, and dischargibility of material shavings, thereby making transmission torque more stabilized under a slippage condition.

In use of such a core drill 1, a handgrip is gripped to put a switch 1a on. Then, a motor 11 is activated, and the rotation is transmitted via the power transmission section 13 to the core bit 12 to allow the core bit 12 to rotate. Pressing the rotating core bit 12 against a predetermined perforating position on, for example a concrete construction permits perforation. During a perforating operation, the blade edge of the core bit 12 will bite into a concrete construction and therefore a load of the motor 11 will increase, and when a transmission torque reaches to a maximum transmission torque, the friction faces 70a of the friction members 70 become slippery, thereby preventing excessive torque from being applied to the motor 11.

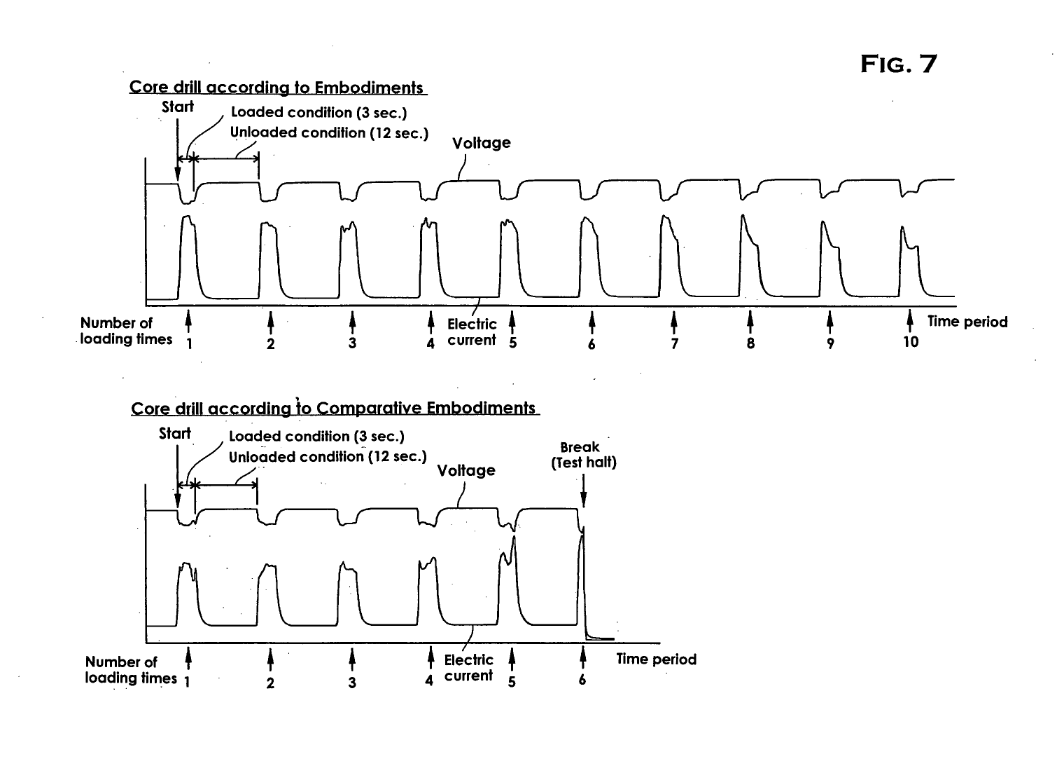

The core drill 1 according to the present embodiments is operable if fixed to a stand 2, as FIG. 6 shows. The core drill 1 has another switch 1c on a side face thereof in addition to the switch 1a on the handgrip, and a change section (not shown) is provided for selecting which switches should be used. In a case where the core drill 1 is used fixed to the stand 2, the switch 1c on the side face of the drill is normally convenient for use, and upon putting the switch 1c on, the motor is activated, and pressing a core bit 12 (not shown) against a predetermined perforating position allows a perforating operation as done with the use of the above-described hand-held core drill.

Slip Operation Tests of the Power Transmission Section of the Core Drill

Slip operation tests were conducted with respect to the core drill 1 of Embodiments and that of Comparative Embodiment. In the core drill of Comparative Embodiment, conventional components were used as an equivalent to the gear 30 and the friction members 70 of the power transmission section 13. Specifically, the gear used in Comparative Embodiment and corresponding to the gear 30 does not have any through holes. As a member corresponding to the friction members, ring-shaped friction plates were used. These friction plates have flat side faces, and each of the both side faces is used as a friction face. Further, these friction plates have a thickness of which size is identical to that of the larger-diameter-section 71 of the friction face 70, and have an outer diameter of which size is identical to a size which a distance from the center of the gear 30 to the center of one of the through holes 32 and a radius of the through holes are added. Further, a diameter of the through holes of the friction plates has a size identical to a size which a radius size of the through holes is subtracted from the distance from the center of the gear 30 to the center of one of the through holes 32. Conditions other than these conditions were identical to those of the core drill 1 in Embodiments.

The slip operation tests were conducted in a manner that the core drill in action under a no-loading condition was intermittently imposed torque loads, which exceed the maximum transmission torque, thereby allowing the friction members of the power transmission section to slip. Specifically, loads of 3 seconds were thrown repeatedly with intervals of unload of 12 seconds. The tests were conducted with the loads thrown 10 times. Test results are shown in FIG. 7.

As FIG. 7 shows, the core drill of Comparative Embodiment suffered seizure at the friction plate thereof when a sixth load was thrown, thereby the test was suspended at the moment. In contrast, the core drill of Embodiments did not suffer any seizure even after a 10th load was thrown. Therefore, the core drill of Embodiments was subjected to the above slip operation test again after a two-hour cooling period from completion of the test, which was assumed single cycle. The slip operation test was conducted five cycles after completion of an initial test, however no seizure was confirmed. From the test results, it was confirmed that the power transmission section of the core drill of Embodiments is capable of transmitting predetermined torque under a slip condition for a long period of time in a stable manner.

1. A power transmission device for a power tool, comprising: a gear to which rotation from a power source is input; a disk-shaped rotator, which is disposed coaxially with the gear and transmits rotation of the gear to the tip tool side; friction members, which are installed between said gear and rotator and kept pressed against the side face or faces of the gear and/or rotator, and said power transmission device transmitting rotation of the gear to the rotator with the use of friction caused between the gear and/or rotator and the friction members,
wherein said friction members have two or more friction faces which are spaced apart from each other.

2. A power transmission device for a power tool according to claim 1, wherein said friction members are fitted into said gear.

3. A power transmission device for a power tool according to claim 2, wherein said friction members comprises two or more friction pieces, which pieces being independently detachable with respect to said gear, and each friction piece has said friction face.

4. A power transmission device for a power tool according to claim 1, wherein said friction face is circular.

5. A power tool, which is equipped with the power transmission device according to claim 1.

6. A core drill, which is equipped with the power transmission device according to claim 1.

7. A power transmission device for a power tool according to claim 2, wherein said friction face is circular.

8. A power transmission device for a power tool according to claim 3, wherein said friction face is circular.

9. A power tool, which is equipped with the power transmission device according to claim 2.

10. A power tool, which is equipped with the power transmission device according to claim 3.

11. A power tool, which is equipped with the power transmission device according to claim 4.

12. A power tool, which is equipped with the power transmission device according to claim 7.

13. A power tool, which is equipped with the power transmission device according to claim 8.

14. A core drill, which is equipped with the power transmission device according to claim 2.

15. A core drill, which is equipped with the power transmission device according to claim 3.

15. A core drill, which is equipped with the power transmission device according to claim 4.

16. A core drill, which is equipped with the power transmission device according to claim 7.

17. A core drill, which is equipped with the power transmission device according to claim 8.
